(19) United States
(12) Patent Application Publication
(10) Pub. No.: US 2023/0278931 A1
(43) Pub. Date: Sep. 7, 2023

(54) METHOD FOR PREPARING PARTICULATE METAL OXIDE MATERIALS

(71) Applicant: UCHICAGO ARGONNE, LLC, Chicago, IL (US)

(72) Inventors: Yuepeng ZHANG, Naperville, IL (US); John HRYN, Hawthorn Woods, IL (US); Gregory K. KRUMDICK, Homer Glen, IL (US); Jungkuk LEE, Bolingbrook, IL (US)

(73) Assignee: UCHICAGO ARGONNE, LLC, Chicago, IL (US)

(21) Appl. No.: 18/116,158

(22) Filed: Mar. 1, 2023

Related U.S. Application Data
(60) Provisional application No. 63/315,214, filed on Mar. 1, 2022.

(51) Int. Cl. C04B 35/622; C04B 35/626; C04B 35/634; C04B 41/00

(52) U.S. Cl. CPC C04B 35/62231; C04B 35/62645; C04B 35/63444; C04B 41/0045; C04B 41/0072; C04B 2235/32; C04B 2235/48; C04B 2235/6583

(57) ABSTRACT

A method for preparing metal oxide and ceramic oxide nano- and microparticulate materials is described herein. The method comprises irradiating a precursor material with high energy pulsed-light flashes in an oxygen-containing atmosphere. The precursor materials comprise thin films, fibers, or particles of subnano-, nano-, or microscale dimension, which are composed of metal ions dispersed in an amorphous or partially crystalline polymer matrix in a ratio necessary to form target metal oxide or ceramic oxide when reacted with oxygen (i.e., the precursor material does not include any metal oxide phase). The irradiation of the precursor material in an oxygen-containing atmosphere decomposes and removes the polymers and anions from the precursor, and also oxidizes the metal ions within the precursor materials to form metal oxide or ceramic oxide particulates.

### CROSS-REFERENCE TO RELATED APPLICATIONS

This application claims the benefit of U.S. Provisional No. 63/315,214, filed on Mar. 1, 2022, which is incorporated herein by reference in its entirety.

### CONTRACTUAL ORIGIN OF THE INVENTION

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to methods for preparing particulate metal oxide materials, such as metal and ceramic oxide nanoparticles and microparticles.

### BACKGROUND

Metal and ceramic oxide materials are important materials for energy-storage, sensing, catalytical, and dielectric applications. Garnet-type solid-state lithium oxide electrolytes, such as lithium lanthanum zirconium oxide (Li₇La₃Zr₂O₁₂ or LLZO), have reported good ionic conductivity, high thermal stability, and a relatively large electrochemical window. Barium titanate (BaTiO₃ or BTO) particulates can be used in capacitors and electromechanical transducers. Iron oxides (Fe₃O₄) are magnetic materials that can be used for biomolecular separation, microwave adsorption, and biomedicine. Iridium oxide (IrO₂) are important catalysts used in fuel cell electrodes. The manufacturing challenges associated with oxides, especially oxide ceramics are high synthesis temperatures (e.g., often above 1100° C. for LLZO and BTO) and long sintering times (e.g., can be as long as 24 hours), which are required to reach typical homogeneity and density. For such high production temperatures, phase segregation and grain coarsening in ceramics are common issues. In addition, the high-temperature-fabricated oxides and ceramics often show facet grains and micro-cracks at the facet grain boundaries, causing mechanical failure or performance degradation.

The facet grain morphology also causes increased surface roughness when the oxide particles are used in a film, e.g., LLZO electrolyte films with facet LLZO grains lead to point contact rather than plane contact with the solid electrode layer, resulting in high interfacial resistance. On the other hand, mechanical failures, such as cracks at facet-grain boundaries can also cause fractures during charge-discharge cycling of batteries. Thus, it is important to develop alternative thermal processes that can mitigate the above issues.

Flash lamp annealing (also referred to as flash lamp curing) is one of the fastest thermal processing technologies that facilitates microstructure engineering and nanostructure formation. During flash lamp annealing, high energy-density pulsed light (HEPL) is flashed on a material in a split second e.g., usually between 0.01 milliseconds (ms) and 10 ms. Because of the short process duration, the heated materials often do not reach thermal equilibrium as in the case of regular isothermal annealing, nor are they subject to significant thermal diffusion processes like the conventional oven thermal treatment. Thus, annealing can effectively control crystallization and the microstructure of the materials. This method has been applied for dopant activation and high-k material crystallization in the semiconductor industry, as well as in thermal treatment of transparent conductive oxides for thin film photovoltaic and flat-panel displays.

Despite the development of flash lamp annealing for many applications, this technology has not been widely applied to ceramic material processing, due to the fact that ceramic sintering requires sufficient time and diffusion activities for samples to achieve good homogeneity, which typically is not compatible with the speed of flash lamp annealing.

There is an ongoing need for alternative methods for preparing metal oxide materials, including metal oxide ceramics. The methods described herein address this need. Our technology not only showed rapid formation of nanostructured oxide ceramics but also showed good composition and microstructure control of these ceramic particulates. Phase segregation typically observed in the conventional isothermal oven annealed ceramics (due to diffusion) has been effectively suppressed by HEPL.

### SUMMARY

A new, rapid method for preparing metal oxide fibers and particles is described herein. The method comprises irradiating a precursor material with high energy-density pulsed-light flashes in an oxygen-containing atmosphere. The precursor material comprises metal cations dispersed in a polymeric matrix (e.g., metal cations and their respective anions from one or more salts dissolved and dispersed in one or more polymers). The metal cations are present in the precursor material with the metal ion stoichiometric ratio of a target metal oxide material. For example, if the target metal oxide is Li₇La₃Zr₂O₁₂, the metal ions are Li, La, and Zr in a respective atomic ratio of 7:3:2; and if the target metal oxide is BaTiO₃, the metal ions are Ba and Ti in a 1:1 ratio. The precursor material can be in the form of thin films, nano-particulates, or micro-particulates (e.g., nanofibers, microfibers, nanoparticles, and/or microparticles) with at least one dimension that is less than 100 µm (e.g., a thin film thickness, or an average diameter of the fibers or particles, in the range of about 1 nm to about 100 µm). Energy from the pulsed-light flashes rapidly heats the precursor materials, burning away the polymeric matrix and facilitating reaction of the metal ions with oxygen and each other to form a nano- or microparticulate metal or ceramic oxide material. The resulting product comprises metal or ceramic oxide particles or fibers in the nanometer to micrometer size range, depending on the particle or fiber diameter of the precursor material. The particles of the particulate metal oxide have an average particle size in the range of about 0.1 nm to about 50 µm. In some embodiments, particles of the particulate metal oxide have an average particle size in the range of about 5 nm to about 50 nm.

The precursor material is formed by dissolving one or more metal salts (e.g., iron nitrate, nickel nitrate, lithium nitrate, titanium acetate, lanthanum acetate hydrate, zirconium oxynitrate hydrate, and the like) and one or more polymers (e.g., polyvinylpyrrolidone (PVP), polyethylene oxide (PEO), polyvinyl alcohol (PVA), and the like) in a solvent in which the polymer and metal salts are soluble, and then forming films or fibers or particles from the resulting solution with subnanometer to micrometer thicknesses or cross-sectional dimensions, e.g., by sol gel casting, drop casting, blade casting, spin coating, slot-die coating, screen printing, ink jet printing, aerosol jet printing, flexographic printing, gravure coating or printing, electrospinning, electrospraying, melt blowing, melt spinning, aerosol spray, or other similar techniques. The precursor material is irradiated with HEPL with a high intensity xenon flash lamp or similar light source. Preferably, the precursor material is irradiated in a thin layer (e.g., about 0.0001 mm to 0.5 mm) to ensure effective light transmission. HEPL irradiation employs ultrashort (e.g., 0.01 ms to 10 ms) pulses of light from a broadband source, such as a xenon flash lamp, to induce rapid transient heating of the illuminated fibers or particles. The precursor material is confined to a reaction chamber to avoid excessive particle dispersion due to gases ablating from the precursor during irradiation. Many metal and ceramic oxide nanoparticle and microparticle materials are useful as solid electrolytes and electrodes in lithium battery systems, such as LLZO particles and lithium iron phosphate (LFP) particles. Many metal and ceramic oxide nanoparticles are also useful as, e.g., dielectric, ferroelectric, piezoelectric, pyroelectric, ferromagnetic, magnetoresistive, superconductive and electro-optical materials, as well as drug delivery systems.

Amorphous film, particulate, and fibrous precursor materials with nano- to micrometer cross-sectional dimensions are prepared by sol gel process, drop casting, blade casting, spin coating, slot-die coating, screen printing, ink jet printing, aerosol jet printing, flexographic printing, gravure coating or printing, electrospinning, electrospraying, spinning, melt spinning, melt blowing, and the like, which techniques are well known in the art. The polymeric portion of the precursor may optionally be removed from their substrate by mechanical separation or low temperature annealing if free-standing precursor materials are desirable for the subsequent rapid thermal treatment. Optionally, the as-formed precursor material can be annealed at a relatively low temperature below the formation temperature of the target metal oxide, and preferably below the decomposition temperature of the polymer, in order to stabilize the morphology of the precursor material.

The precursor materials are irradiated using high energy pulsed light flashing with sub-millisecond to millisecond range pulse lengths under an oxygen-containing atmosphere, such as oxygen gas, air, or a mixture of oxygen with an inert gas such as argon, preferably pure oxygen (e.g., > 99% pure). This step achieves two useful results - oxidative decomposition and removal of the polymeric matrix, and reaction of the metal ions with oxygen to form the subnano-, nano- or microparticulate metal or ceramic oxide product. Preferably, the irradiation is performed in a confinement chamber for an easy harvesting of the metal oxide or ceramic product by preventing ablation gases from dispersing and scattering the material within the apparatus. The process can be carried out in a discrete sample chamber for preparation of limited batches of materials. Alternatively, the process can be automated using a conveyor system to move the precursor material through a chamber with a confined reaction zone, optionally using multiple lamps to flash the material moving through the reaction zone, and then collecting the product ceramic particles on a continuous basis.

Some advantages of the process described herein are:

(a) The process starts with subnanometer, nanometer or micrometer scale precursor materials that do not require long diffusion times for the oxidation reactions involved in metal oxide or ceramic formation, which makes it possible to generate ceramic and oxide structures with homogeneous composition by rapid thermal annealing.

(b) Fast processing times in range of a few hundred microseconds to a few thousands of milliseconds are achieved, which is more than 10000 times faster than common ceramic sintering method (which usually takes several hours to several tens of hours).

(c) The process uses low effective annealing temperatures and thermal budget resulting from the nanostructured precursor phase and very short diffusion pathways for reaction of the metal ions.

(d) The product of the method is a subnano-, nano- or microstructured metal or ceramic oxide. Nanomaterials, in particular, often show superior properties and functionalities compared to larger particulate materials.

The term “particulate” as used herein in reference to metal oxides refers to both particles and fibers of the metal oxide. The term “metal oxide” as used herein refers to simple metal oxides, complex metal oxides, as well as metal oxides commonly referred to as ceramics or ceramic oxides.

The following non-limiting embodiments are described below to illustrate certain features of the methods described herein.

Embodiment 1 is a method for preparing a particulate metal oxide comprising irradiating a precursor material with high energy pulsed-light flashes in an oxygen-containing atmosphere; wherein the precursor material is in the form of a thin film, fibers, or particles which have at least one dimension that is within the subnanometer, nanometer, and/or micrometer size range, and the precursor material comprises metal ions and charge-balancing anions from one or more salts dispersed in an amorphous or partially crystalline matrix of a polymer or a mixture of more than one polymer; the metal ions of the salts are present in the precursor material in a ratio of metal ions corresponding to the ratio of metal ions in the particulate metal oxide being prepared; the precursor material is irradiated with one or more pulses of light at an energy density of about 0.3 to about 60 J/cm² per pulse (e.g., at least 0.3, 0.5, 0.8, 1, 1.5, 2, 3, 4, 5, 6, 7, 8, 9, or 10 J/cm², and/or up to 15, 20, 25, 30, 35, 40, 45, 50, 55, or 60 J/cm²) at pulse durations in the range of about 0.01 ms to 10 ms (e.g., at least 0.01, 0.05, 0.1, 0.5 ms, and/or up to 1, 2, 3, 4, 5, 6, 7, 8, 9, or 10 ms), a pulse repetition rate in the range of about 0.01 Hz to about 10 Hz (e.g., at least 0.01, 0.05, 0.1, 0.5, or 1 Hz, and/or up to 2, 3, 4, 5, 6, 7, 8, 9, or 10 Hz), and the number of pulses between 1 to 10000 (e.g., at least 1, 5, 10, 50, or 100 pulses, and/or up to 300, 500, 800, 1000, 2000, 5000, or 10000 pulses); the irradiation is continued for a number of pulses necessary to provide an amount of energy sufficient to oxidize and decompose the polymer, and oxidize the metal ions to form the particulate metal oxide; and wherein the particulate metal oxide comprises particles and/or fibers having at least one dimension that is within the subnanometer, nanometer, and/or micrometer size range. More than one particulate material can be synthesized at the same time by irradiating a mixture of multiple precursor materials with different mass ratios of metal ions and/or different morphological forms of the precursor materials (e.g., fibers and particles).

Embodiment 2 is the method of embodiment 1, wherein the irradiation is continued for up to about 10 pulses.

Embodiment 3 is the method of embodiment 1 or 2, wherein the pulse repetition rate is up to about 2 Hz.

Embodiment 4 is the method of any one of embodiments 1 to 3, wherein the energy density of the pulses is up to about 5.6 J/cm².

Embodiment 5 is the method of any one of embodiments 1 to 4, wherein the pulse duration is up to about 1 ms.

Embodiment 6 is the method of any one of embodiments 1 to 5, wherein the polymer is selected from the group consisting of polyvinylpyrrolidone (PVP), polyethylene oxide (PEO), polyvinyl alcohol (PVA), polyurethane (PU), polylactic acid (PLA), cellulose acetate, and a combination of two or more of the foregoing.

Embodiment 7 is the method of any one of embodiments 1 to 6, wherein the metal salts are selected from the group consisting of metal nitrates, metal oxynitrates, metal alkoxides, chlorides, propoxides, orthosilicates and a combination of two or more of the foregoing.

Embodiment 8 is the method of any one of embodiments 1 to 7, wherein the total concentration of salts in the precursor material is about 5 to about 95 percent by weight (wt%) based on combined weight of the polymer and salts (e.g., at least about 5, 10, 15, 20, 25, 30, 35, or 40 percent, and/or up to 50, 60, 70, 80, 90, or 95 percent).

Embodiment 9 is the method of any one of embodiments 1 to 8, wherein the oxygen-containing atmosphere comprises at least about 20% oxygen, e.g., at least about 21%, 30%, 40%, 50%, 60%, 70%, 80%, 90%, 95%, or 100% oxygen.

Embodiment 10 is the method of any one of embodiments 1 to 9, wherein the particulate metal oxide comprises particles having an average particle size in the range of about 0.1 nm to about 50 µm (e.g., up to 1, 10, 100, 1000, 2000, 3000, 4000, 5000, 10000, 20000, 30000, 40000, or 50000 nm).

Embodiment 11 is the method of any one of embodiments 1 to 10, wherein the particulate metal oxide comprises particles having an average particle size in the range of about 50 nm to about 500 nm.

Embodiment 12 is a method for preparing a particulate metal oxide comprising the steps of:
(a) preparing a solution of one or more metal salts and one or more polymers in a solvent in which the polymers and metal salts are soluble;
(b) fabricating a precursor material comprising a thin film, or fibers, or particles having cross-sectional dimensions in the range of about 1 nm to about 100 µm from the solution of step (a); wherein the precursor material comprises a film, or fibers, or particles comprising metal ions from the salts dispersed in an amorphous or partially crystalline matrix of the polymer; and the metal ions are present in the precursor material in a ratio corresponding to the ratio of metal ions in the particulate metal oxide; and
(c) irradiating the precursor material with high energy pulsed-light flashes in an oxygen-containing atmosphere with one or more pulses of light at an energy density of about 0.3 to about 60 J/cm² per pulse (e.g., at least 0.3, 0.5, 0.8, 1, 1.5, 2, 3, 4, 5, 6, 7, 8, 9, or 10 J/cm², and/or up to 15, 20, 25, 30, 35, 40, 45, 50, 55, or 60 J/cm²), at pulse durations in the range of about 0.01 ms to 10 ms (e.g., at least 0.01, 0.05, 0.1, or 0.5 ms, and/or up to 1, 2, 3, 4, 5, 6, 7, 8, 9, or 10 ms), a pulse repetition rate in the range of about 0.01 Hz to about 10 Hz (e.g., at least 0.01, 0.05, 0.1, 0.5, or 1 Hz, and/or up to 2, 3, 4, 5, 6, 7, 8, 9, or 10 Hz); ; and continuing the irradiation for a number of pulses necessary to provide sufficient photon energy to oxidize and decompose the polymer in the precursor materials, and oxidize the metal ions to form subnano-, or nano-, or microparticulates, or a combination of these particulate metal oxide forms, e.g., for the number of pulses between 1 to 10000 (e.g., at least 1, 5, 10, 50, or 100 pulses, and/or up to 300, 500, 800, 1000, 2000, 5000, or 10000 pulses).

Embodiment 13 is the method of embodiment 12, wherein the precursor material is fabricated in step (b) by a process selected from the group consisting of a sol gel process, drop casting, blade casting, spin coating, slot-die coating, screen printing, ink jet printing, aerosol jet printing, flexographic printing, gravure coating or printing, melt blowing, electrospinning, electrospraying, spinning, and melt spinning.

Embodiment 14 is the method of embodiment 12 or 13, wherein the solvent is selected from the group consisting of an amide solvent; a carboxylic acid solvent; an acetic acid solvent, an chloroform solvent, an alcohol solvent such as ethanol, acetone, isopropyl alcohol (IPA); an organosulfur compound such as dimethyl sulfoxide (DMSO), an organic solvent such as dimethylacetamide (DMAc), dimethylformamide (DMF), and dichloroethane; an aqueous solvent such as water, and a combination of two or more of the foregoing.

Embodiment 15 is the method of any one of embodiments 12 to 14, wherein the polymer is selected from the group consisting of polyvinylpyrrolidone (PVP), polyethylene oxide (PEO), polyvinyl alcohol (PVA), cellulose acetate, polycarbonate (PC), polyetheretherketone (PEEK), and a combination of two or more of the foregoing.

Embodiment 16 is the method of any one of embodiments 12 to 15, wherein the polymer is PVP.

Embodiment 17 is the method of any one of embodiments 12 to 16, wherein the metal salts are selected from the group consisting of metal nitrates, metal oxynitrates, metal alkoxides, chlorides, propoxides, orthosilicates, and a combination of two or more of the foregoing.

Embodiment 18 is the method of any one of embodiments 12 to 17, wherein the total concentration of salts in the precursor material is about 5 to about 95 wt% based on combined weight of the polymer and salts.

Embodiment 19 is the method of any one of embodiments 12 to 18, wherein the oxygen-containing atmosphere comprises at least about 20% oxygen.

Embodiment 20 is the method of any one of embodiments 12 to 19, wherein the pulse repetition rate is up to about 2 Hz.

Embodiment 21 is the method of any one of embodiments 12 to 20, wherein the energy density of the pulses is up to about 5.6 J/cm².

Embodiment 22 is the method of any one of embodiments 12 to 21, wherein, wherein the pulse duration is up to about 1 ms.

Embodiment 23 is the method of any one of embodiments 12 to 22, wherein the particulate metal oxide comprises particles having an average particle size in the range of about 5 nm to about 5000 nm.

Embodiment 24 is the method of any one of embodiments 12 to 23, wherein the particulate metal oxide is selected from the group consisting of Li₇La₃Zr₂O₁₂, Al-doped Li₇La₃Zr₂O₁₂, Ti-doped Li₇La₃Zr₂O₁₂, Ga-doped Li₇La₃Zr₂O₁₂, and BaTiO₃.

Embodiment 25 is the method of any one of embodiments 12 to 24, further comprising the step of heating the precursor material at a temperature below the decomposition temperature of the polymer and below the formation temperature of the metal oxide to stabilize the morphology of the particles or fibers of the precursor material prior to step (c).

The methods and materials described herein comprise certain novel features hereinafter fully described, which are illustrated in the accompanying drawings and the following description, and which are particularly pointed out in the appended claims. It is to be understood that various changes in the details may be made without departing from the spirit, or sacrificing any of the advantages of the systems, electrochemical reactors, and methods described herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a scanning electron micrographic (SEM) image of a typical precursor material made from metal ion containing polymer fibers (a) and a transmission electron micrographic (TEM) image (b) of these polymer precursor fibers after the pre-irradiation treatment at T=350° C.

FIG. 2 shows TEM images of the resulting nanoparticulate product after HEPL treatment.

FIG. 3 shows optical photographs of two identical Al-doped LLZO precursor materials before (top) and after (bottom) HEPL treatment (a) with oxygen supply during treatment; and (b) without oxygen supply during treatment. Inset of panel (a) is a high resolution TEM image of the LLZO fiber, which shows good crystallinity.

FIG. 4 shows low magnification (top) and high magnification (bottom) TEM images of Al-doped LLZO precursor materials after HEPL treatment at different light energy densities: (a) 0.43 J/cm²; (b) 1.32 J/cm²; (c) 1.86 J/cm²; and 5.61 J/cm².

FIG. 5 provides photographs of (a) an as-spun Al-doped LLZO precursor fiber film; and (b) the product oxide fiber sample after the HEPL treatment with a 4.6 J/cm² energy density light pulse.

FIG. 6 provides photographs and SEM images of (a) an as-spun BTO precursor fiber film; and (b) the product oxide fiber sample after irradiation by a 4.6 J/cm² energy density light pulse.

### DETAILED DESCRIPTION

A method for preparing metal oxide nanoparticles is described herein. The method comprises irradiating a precursor material with high energy pulsed-light flashes in an oxygen-containing atmosphere. The precursor material comprises a thin film or particles of metal ions dispersed in a polymer matrix, wherein the metal ions are present in the precursor material in a ratio corresponding to the ratio of metal ions in a target metal oxide (i.e., the precursor material does not include a ceramic or metal oxide phase corresponding to the target metal oxide). The metal ions are provided by metal salts dissolved in the polymer matrix. Thin film precursors have a thickness in the sub-nanometer, nanometer, or micrometer range, and particulate precursors comprise subnanofibers, nanofibers, subnanoparticles, nanoparticles, microfibers, and/or microparticles. The irradiation of the precursor material in an oxygen-containing atmosphere decomposes and removes the polymers and anion components of the salts (i.e., by thermal degradation forming and releasing gases, such as CO₂, NO₂, NOₓ, and the like), and also oxidizes the metal ions that are dispersed within the precursor material to form metal oxide subnano-, nano- or microparticles. The process can be used to generate a broad range of metal oxide materials used in many applications in addition to batteries (e.g., LLZO, such as Al-doped Li₇La₃Zr₂O₁₂, undoped Li₇La₃Zr₂O₁₂, Ti-doped Li₇La₃Zr₂O₁₂, and Ga-doped Li₇La₃Zr₂O₁₂; LaSrCoFeOₓ fuel cells electrodes; BaTiO₃ dielectrics; Fe₃O₄ ferromagnetic materials; and the like).

The nanofibers or microfibers of precursor compositions can be fabricated using a high-yield roll-to-roll (R2R) electrospinning as described, e.g., in co-pending U.S. Application Serial No. 17/490,956 filed on Oct. 1, 2021, which is incorporated herein by reference in its entirety. Alternatively, the precursor material can be in the form of subnano-, nano-, or micrometer thick films, or nano- or microparticles. Such nano- or microscale materials also can be produced, e.g., sol gel synthesis, drop casting, blade casting, spin coating, slot-die coating, screen printing, ink jet printing, aerosol jet printing, flexographic printing, gravure coating or printing, melt blowing, electrospray, electroblowing, spinning, melt spinning, and any other fabrication methods known in the art.

In one embodiment, the process for preparing the metal oxide (e.g., a simple metal oxide, complex metal oxide, or ceramic oxide) subnano-, or nano-, or microparticles described herein comprises:

(a) Preparing a solution of one or more metal salts and a polymer in a solvent in which the salts and polymer are soluble. If more than one metal salt is used, the concentration of each of the metal salts is determined based on the atomic percentage of the different metal ions in the target metal oxide or ceramic oxide products. The target oxide products can contain one or more oxides. The anions of the metal salts are selected to provide adequate solubility and to avoid undesired side reactions during processing.

(b) Fabricating polymer-based subnano-, nano-, or micrometer cross-sectional film, fiber or particulate precursor material from the solution of salts and polymer using wet deposition methods, such as drop casting, blade casting, spin coating, slot-die coating, screen printing, ink jet printing, aerosol jet printing, flexographic printing, gravure coating or printing, melt blowing, electrospinning, electrospray, electroblowing, spinning, melt spinning, or sol-gel synthesis.

(c) Pre-irradiation thermal treatment of the precursor material. The as-formed precursor films, fibers or particles can be irradiated directly or stabilized first using another thermal annealing method to maintain the micro- or nanostructure morphology. The pre-irradiation treatment is performed at temperatures lower than the formation temperature of the product oxide or ceramic. In some preferred embodiments, the pre-irradiation treatment is performed at temperatures lower than the polymer decomposition temperature to maintain the particulate or fibrous morphology of the precursor materials.

(d) Irradiating the precursor material with HEPL fast lamp annealing. The precursor material is placed in a confined sample container that includes a transparent window and is irradiated through the window with high intensity light generated by flash lamps. The polymers are decomposed by reacting with the reactive gas during annealing. The decomposition of the polymer exposes the metal ions to the reactive gas and forms the final metal oxide or ceramic products, such as alumina, zirconia, barium titanate, and a mixture of two or more of these oxides. During the irradiation process, the energy density, applied voltage across the lamp, pulse length, number of pulses, repetition rate of the light, and reactive gas content are adjusted to obtain the desired product material crystal structure, morphology, grain morphology, and grain size and size distribution.

(e) After the irradiation step, the resulting metal oxide particulates are collected, and can be characterized for material properties such as XRD, SEM, TEM, Raman, XPS, dielectric constant, electrical resistance measurement, if desired.

The polymer component of the precursor materials can be, e.g., PVP, PEO, PVA, PU, PLA, cellulose acetate, and the like. In some embodiments, the polymer has a number average molecular weight in the range of about 20 kiloDaltons (kDa) to about 2,000 kDa, e.g., about 600 to about 1,300 kDa.

The metal salts can be, for example, nitrate, oxynitrate, alkoxide (e.g., methoxide, ethoxide, propoxide, isopropoxide, and the like), chloride, and/or orthosilicate salts of the metals that make up one or more given metal oxide target materials. The metal ion portion of the salts are selected based on the metal oxides or ceramic materials to be prepared, according the metal ions can be alkali metal ions, alkaline earth metal ions, transition metal ions, main group metal ions, lanthanide metal ions, actinide metal ions, and combinations of two or more metal ions from one or more of the aforementioned metallic groups. For example, the metal salts for preparing LLZO would include salts of lithium, lanthanum, and zirconium, whereas the metal salts for preparing barium titanate would include barium and titanium salts. The molar proportions of the different metal ions in the precursor material would correspond to the proportions of the metals in the target metal oxides or ceramic materials. In the case of BTO, the molar proportions of Ba and Ti ions would be about 1:1; whereas for the typical LLZO, Li₇La₃Zr₂O₁₂, the ratio of Li:La:Zr ions would be about 7:3:2. In the case of mixed BTO and LLZO, the ratio of Ba:Ti ions would be about 1:1 and the ratio of Li:La:Zr ions would be about 7:3:2, and the ratio of Ba:Li or Ba:La would be the ratio of BTO versus LLZO in the target final products.

Typically, nanofibers of the precursor material have a fiber diameter in the range of about 10 nm to about 10,000 nm. Fiber lengths for the nanofibers are in the range of about 0.1 µm to about 1 cm.

The precursor materials are formed by dissolving metal salts and polymers in a suitable solvent (e.g., a single solvent or a mixture of two or more solvents) that will dissolve the salts and polymers. Examples of such solvents include, e.g., amides such as dimethylformamide (DMF), carboxylic acids such as acetic acid; alcohols such as, acetone, isopropyl alcohol (IPA), ethanol and chloroform solvent, an organosulfur compound such as dimethyl sulfoxide (DMSO), an organic solvent such as dimethylacetamide (DMAc), dimethylformamide (DMF), and dichloroethane; and aqueous solvent such as water and the like. Multiple solvents may be combined to obtain a mixed solvent system that will adequately dissolve both the polymer and salt components. The polymer component of the precursor can be dissolved in a different solvent or solvent mixture than the solvent(s) used for the salts, and then the separate solutions of salts and polymers can be mixed together to form the ultimate solution used for sol gel process, electrospinning, electrospraying, and the like, if desired. More than one precursor material can be mixed during the precursor preparation, e.g., precursor fibers containing Ba and Ti ions and precursor fibers of Li, La, and Zr ions can be intertwined using co-electrospinning technique, or they can form core-shell structures by using double-sheath electrospinning. In some embodiments, the solvent for the salts is a mixture of dimethylformamide (DMF) and acetic acid (e.g., in a weight ratio of DMF to acetic acid of about 10:1 to about 1:1 (e.g., about 85 wt% DMF and 15 wt% acetic acid (a ratio of 5.67:1)). Optionally, chelating agents, such as ethylenediamine tetraacetic acid (EDTA), crown ethers, and the like can be added to aid in dissolving the metal salts.

The precursor solution containing the metal salt(s) and polymer is then injected via a pump (e.g., a syringe pump) through fine nozzles to which a relatively high voltage of about 4 to about 28 kV has been applied to create an electric field between the nozzles and an oppositely charged or grounded collector. The electric field facilitates the precursor to form microjets directed from the nozzles towards the collectors. Solvent evaporates and polymer nano- or microfibers containing the metal salts are deposited at the collector. Optionally, the precursor material can be heated at a temperature below the formation temperature of the target metal oxide, and preferably below the decomposition or melting point of the polymer to stabilize the morphology of the particles or fibers (e.g., in the range of about 200 to 300° C. for PVP).

The precursor material is then irradiated with HEPL under an oxygen-containing atmosphere to decompose and remove the polymer and oxidize the metal ions to form the target metal oxide and/or ceramic materials. Typically, the precursor materials are sealed in a sample chamber with an optically transparent window or cover, and one or multiple light pulses (e.g., about 1 to about 500 light pulses, preferably about 10 to about 100 light pulses) are flashed through the transparent window or cover to irradiate the material. The light pulses typically are about 0.1 to about 1 ms in duration, at an energy density of about 0.3 to about 5.6 J/cm², at a repetition rate of about 0.5 to about 2 Hz. The sample holder is filled with an oxygen-containing gas, such as pure oxygen, during irradiation. For larger scale preparation, the process can be performed in a continuous manner, e.g., by conveying the precursor materials (preferably in a thin film or a spread of particulates) through a reaction zone in which multiple flash lamps irradiate the precursor as it moves through the reaction zone under an oxygen atmosphere.

The following non-limiting examples are provided to illustrate certain aspects and features of the materials and methods described herein.

### Example 1 Preparation of LLZO Nanoparticulate

Li₇La₃Zr₂O₁₂ (LLZO) is used as an exemplary material to demonstrate the rapid formation of garnet-type ceramic LLZO metal oxide nanostructures. The precursor nanofibers were fabricated by electrospinning using a N,N-dimethylformamide (DMF) based chemical solution that contains fully dissolved lithium nitrate, lanthanum nitrate, zirconium oxynitrate, and polyvinylpyrrolidone (PVP) carrier polymer. The electrospinning voltage was between 8-28 kV. The working distance was between 4-10 inches. The as-spun amorphous polymer precursor nanofibers typically had diameters of several hundred nanometers.

As a specific example of making the un-doped LLZO nanoparticles, a first solution of dimethylformamide (DMF) and acetic acid was prepared with a weight ratio of 85 wt% DMF to 15 wt% acetic acid. 7.7 mmol lithium nitrate, 3 mmol lanthanum(III) nitrate hexahydrate, 2 mmol zirconium(IV) oxynitrate hydrate were dissolved in this solution. A second solution that contains 10 percent by weight (wt%) PVP in DMF was prepared and mixed with the first solution in a 1:1 volume ratio. This resulting precursor solution was used for electrospinning of LLZO precursor nanofibers. During electrospinning, a number of syringes were loaded with the above solutions and connected to electrospinning tubing with needles.

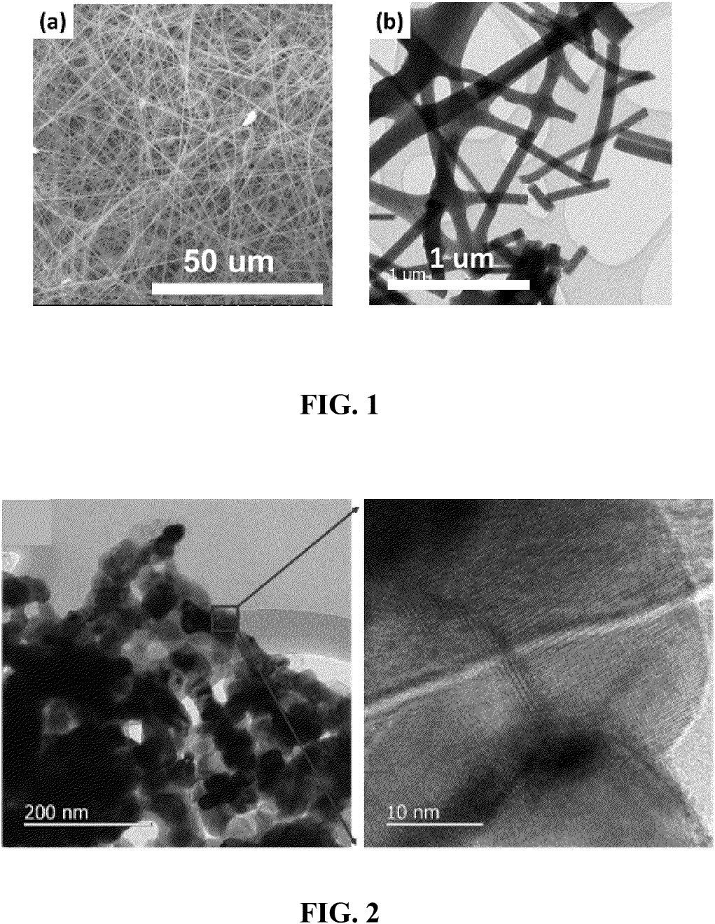

The solutions were pumped continuously from syringes to the needles with a flow rate between 0.1 mL/h to 10 mL/h at the same time, a high voltage in the range of 8-28 kV was applied to the needles to generate nanofibers and a grounded collector was used to collect the electrospun fibers. For Al-doped LLZO, an additional 0.2 mmol of aluminum nitrate nonahydrate was added into the first solution. The nanofibers were then heated between 200-300° C. for 0.5 hours to stabilize the nanofiber morphology of the material. FIG. 1 shows a scanning electron micrographic (SEM) image (a) and transmission electron micrographic (TEM) images (b) of typical as-spun polymer precursor fibers.

The precursor fibers were then placed in a sample holder of a NOVACENTRIX PULSEFORGE 1300 photonic curing apparatus and irradiated by HEPL irradiation. A typical processing condition was 10 overlapped pulses with 4.6 J/cm² pulse energy density per pulse and a 1000 µs (one millisecond) pulse length at a 0.5 Hz repetition rate. During irradiation, oxygen gas was purged in and out of the sample holder. FIG. 2 shows the TEM images of the resulting nanoparticulate after HEPL treatment. Crystalline grains of about 40 to 60 nm grain size were clearly observed. TEM EDS analysis indicated a La/Zr ratio of about 1.5 and an O/Zr ratio of about 6, which is consistent with the target stoichiometric composition of Li₇La₃Zr₂O₁₂.

### Example 2 Effect of Oxygen Content on Metal Oxide Particulate Formation

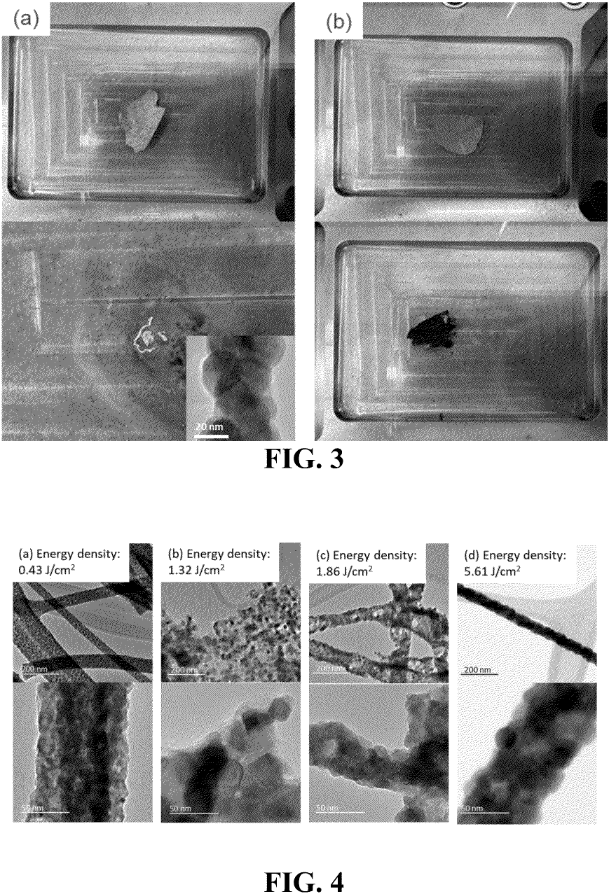

The Al-doped LLZO polymer precursor fibers were prepared as described in Example 1. The precursor fibers were placed in a sample holder (EC-3) of a NOVACENTRIX PULSEFORGE 1300 photonic curing apparatus and irradiated by HEPL in the presence and absence of oxygen. In the presence of oxygen, oxygen was supplied to the EC-3 sample holder with a flow rate of 3.5 L/min, while the EC-3 sample holder was kept ambient atmosphere in the absence of oxygen experiment. For HEPL irradiation, the applied voltage and pulse length was 700V and 500 µs, respectively, giving a light energy density of 3.2 J/cm². One pulse of light was flashed to the precursor fibers for this experiment. FIG. 3 shows photographs of precursor fiber before and after HEPL irradiation (a) in the presence and (b) absence of oxygen. In the presence of oxygen, the precursor fiber is converted into ceramic oxide nanofibers with significant volume changes (by completely removing the polymer matrix), while the precursor fibers turned in to black charcoals in the absence of oxygen . This result clearly demonstrates that the oxygen supply is required to form ceramic metal oxide under HEPL irradiation.

### Example 3 Influence of HEPL Energy Density on Oxide Particulate Morphology

The Al-doped LLZO precursor nanofibers were prepared as described in Example 1. The precursor fiber was placed in sample holder (EC-3) of a NOVACENTRIX PULSEFORGE 1300 photonic curing apparatus and irradiated by HEPL. The irradiation conditions were adjusted to obtain various energy densities. For all experiments, oxygen gas was purged to the sample chamber at a flow rate of 3.5 L/min. FIG. 4 shows TEM images of the product fibers after HEPL irradiation. Different crystallinities, grain morphologies, and grain sizes were observed by modifying the energy density of light pulses. For example, at a low energy density of 0.43 J/cm², the fibers contained a large portion of unremoved polymers, while at 1.86 J/cm2 energy density illumination voids were seen in the product fibers indicating a significant but not complete removal of the precursor polymers during HEPL irradiation. When the energy density was increased to 5.61 J/cm², good crystallinity oxide fibers were observed.

### Example 4. Formation of Metal Oxide Particulate Directly From Polymer Precursor Using HEPL Irradiation

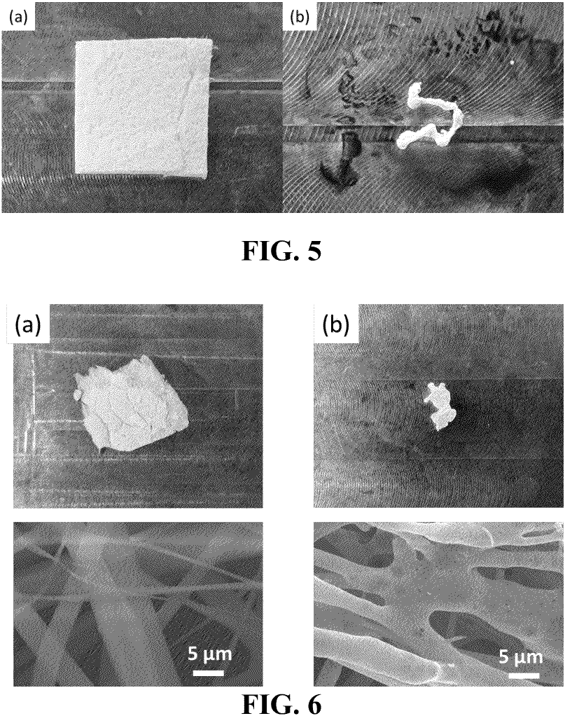

This example is similar to Example 1, but the precursor materials were not thermally pre-treated. The Al-doped as-spun precursor LLZO fibers were prepared by electrospinning as described in Example 1 without heat treatment at 300° C. The as-spun fibers were placed in an EC-3 sample chamber of a NOVACENTRIX PULSEFORGE 1300 photonic curing apparatus and irradiated by HEPL irradiation with oxygen purge. The applied voltage and pulse length were 800 V and 500 µs, respectively, resulting in a single-pulse energy density of 4.6 J/cm². FIG. 5 shows the photographs of the fibers before and after HEPL irradiation. As shown, the as-spun polymer fiber successfully transformed into metal oxide fiber even without heat treatment. This result indicates that the feasibility of HEPL irradiation for direct formation of metal oxide from the as-spun fiber.

### Example 5. Fabrication of Barium Titanium Oxide Particulate From Polymer Precursor Using HEPL Irradiation

In order to confirm the versatility of HEPL irradiation for different metal oxide materials, barium titanium oxides were fabricated as an example. Electrospinning method was used again for BTO precursor fiber material synthesis. The electrospinning solution was prepared by a two-step process of dissolving polyvinylpyrrolidone (PVP) in ethanol to a concentration of 7 wt.% and preparing a second solution of acetic acid with barium acetate added to a 28 wt.% of the solution. The second solution was heated to 60° C. to allow good mixing overnight. The following day, titanium isopropoxide was slowly added to the barium acetate solution. The PVP solution was then added to the barium acetate and allowed to mix for 48 hours to give the final precursor solution. The solution was electrospun at 8-28 kV range with an injection rate of 0.2-1 mL/h. The as-spun precursor fiber was place in the sample holder (EC-3) of a NOVACENTRIX PULSEFORGE 1300 photonic curing apparatus and irradiated by HEPL with 3.5 L/min oxygen flow. The applied voltage and pulse length were 800 V and 500 µs, respectively, giving an energy density of 4.6 J/cm². One pulse of light was flashed for this experiment. FIG. 6 shows photographs and SEM images of (a) as-spun BTO polymer precursor fiber sample; and (b) oxide fiber sample after HEPL irradiation. The HEPL treated sample showed a clear change in fiber morphology and crystallinity feature of the fibers as compared with the as-spun fiber sample.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing materials or methods (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the materials or methods described herein and does not pose a limitation on the scope of the claims unless otherwise stated. No language in the specification should be construed as indicating any non-claimed element as essential to the practice of the claims.

Preferred embodiments are described herein, including the best mode known to the inventors for carrying out the claimed invention. Variations of those preferred embodiments may become apparent to those of ordinary skill in the art upon reading the foregoing description. The inventors expect skilled artisans to employ such variations as appropriate, and the inventors intend for the claimed invention to be practiced otherwise than as specifically described herein. Accordingly, the claimed invention includes all modifications and equivalents of the subject matter recited in the claims appended hereto as permitted by applicable law. Moreover, any combination of the above-described elements in all possible variations thereof is encompassed by the claimed invention unless otherwise indicated herein or otherwise clearly contradicted by context.

The embodiments of the invention in which an exclusive property or privilege is claimed are defined as follows:

1. A method for preparing a particulate metal oxide comprising fibers and/or particles having at least one-dimension that is within the subnanometer, nanometer, and/or micrometer size range; the method comprising irradiating a precursor material with high energy pulsed-light flashes in an oxygen-containing atmosphere; wherein the precursor material comprises a thin film, fibers, and/or particles which have at least one-dimension that is within the subnanometer, nanometer, and/or micrometer size range; wherein the precursor material comprises metal ions from one or more salts dispersed in an amorphous or partially crystalline polymer matrix; the metal ions of the salts are present in the precursor materials in a ratio corresponding to the ratio of metal ions in the particulate metal oxide; the precursor material is irradiated with one or more flashes of pulsed light at energy levels of about 0.3 to about 60 J/cm² per pulse, at pulse durations in the range of about 0.01 ms to 10 ms, a pulse repetition rate in the range of about 0.01 Hz to about 10 Hz; and the irradiation is continued for a number of pulses in the range of 1 to 10000 pulses necessary to apply sufficient energy to the precursor material to oxidize and decompose the polymer, and oxidize the metal ions to form the particulate metal oxide.

2. The method of claim 1, wherein the irradiation is continued for up to about 10 pulses.

3. The method of claim 1, wherein the pulse repetition rate is up to about 2 Hz.

4. The method of claim 1, wherein, wherein the energy density of the pulses is up to about 5.6 J/cm².

5. The method of claim 1, wherein the pulse duration is up to about 1 ms.

6. The method of claim 1, wherein the polymer is selected from the group consisting of polyvinylpyrrolidone (PVP), polyethylene oxide (PEO), polyvinyl alcohol (PVA), polyurethane (PU), polylactic acid (PLA), cellulose acetate, and a combination of two or more of the foregoing.

7. The method of claim 1, wherein the metal salts are selected from the group consisting of metal nitrates, metal oxynitrates, metal alkoxides, metal oxynitrates, metal alkoxides, chlorides, propoxides, orthosilicates, and a combination of two or more of the foregoing.

8. The method of claim 1, wherein the total concentration of salts in the precursor material is about 5 to about 95 percent by weight (wt%) based on combined weight of the polymer and salts.

9. The method of claim 1, wherein the oxygen-containing atmosphere comprises at least about 20% oxygen.

10. The method of claim 1, wherein the particulate metal oxide comprises particles having an average particle size in the range of about 0.1 nm to about 50 µm.

11. The method of claim 1, wherein the particulate metal oxide comprises particles having an average particle size in the range of about 50 nm to about 500 nm.

12. A method for preparing a particulate metal oxide comprising fibers and/or particles having at least one-dimension that is within the subnanometer, nanometer, and/or micrometer size range; the method comprising the steps of:
(a) preparing a solution of one or more metal salts and one or more polymers in a solvent in which the polymers and metal salts are soluble;
(b) fabricating a precursor material comprising one or more thin films, fibers, or particles from the solution of step (a); wherein the precursor material comprises metal ions from the salts dispersed in an amorphous or partially crystalline matrix of the polymers; the metal ions are present in the precursor material in a ratio corresponding to the ratio of metal ions in the particulate metal oxide; the thin films have a thickness in the range of about 0.1 nm to about 100 µm; the fibers have a cross-sectional dimension in the range of about 0.1 nm to about 100 µm; and the and particles have a cross-sectional dimension in the range of about 0.1 nm to about 100 µm;
(c) irradiating the precursor material with high energy pulsed-light flashes in an oxygen-containing atmosphere with one or more flashes of pulsed light at energy levels of about 0.3 to about 60 J/cm² per pulse, at pulse durations in the range of about 0.01 to 10 ms, and a pulse repetition rate in the range of about 0.01 to about 10 Hz; and continuing the irradiation for a number of pulses in the range of 1 to 10000 pulses necessary to provide sufficient photon energy to oxidize and decompose the polymer in the precursor material, and oxidize the metal ions to form the particulate metal oxide.

13. The method of claim 12, wherein the precursor material is fabricated in step (b) by a process selected from the group consisting of drop casting, blade casting, spin coating, slot-die coating, screen printing, ink jet printing, aerosol jet printing, flexographic printing, gravure coating or printing, melt blowing, electrospinning, electrospraying, spinning, melt spinning, and a sol-gel process.

14. The method of claim 12, wherein the solvent is selected from the group consisting of an amide solvent; a carboxylic acid solvent; an alcohol solvent; an organic carbonate solvent; an organosulfur compound, dimethyl sulfoxide (DMSO), dimethylacetamide (DMAc), dimethylformamide (DMF), dichloroethane, and aqueous solvent.

15. The method of claim 12, wherein the polymer is selected from the group consisting of polyvinylpyrrolidone (PVP), polyethylene oxide (PEO), polyvinyl alcohol (PVA), polyurethane (PU), polylactic acid (PLA), cellulose acetate, and a combination of two or more of the foregoing.

16. The method of claim 12, wherein the polymer is PVP.

17. The method of claim 12, wherein the metal salts are selected from the group consisting of metal nitrates, metal oxynitrates, metal alkoxides, chlorides, propoxides, orthosilicates and a combination of two or more of the foregoing.

18. The method of claim 12, wherein the total concentration of salts in the precursor material is about 5 to about 95 wt% based on combined weight of the polymer and salts.

19. The method of claim 12, wherein the oxygen-containing atmosphere comprises at least about 20% oxygen.

20. The method of claim 12, wherein the pulse repetition rate is up to about 5 Hz.

21. The method of claim 12, wherein, wherein the energy density of the pulses is up to about 4.6 J/cm².

22. The method of claim 12, wherein, wherein the pulse duration is up to about 1 ms.

23. The method of claim 12, wherein the nanoparticulate metal oxide comprises particles having an average particle diameter in the range of about 50 nm to about 500 nm.

24. The method of claim 1, wherein the particulate metal oxide is selected from the group consisting of Li₇La₃Zr₂O₁₂, Al-doped Li₇La₃Zr₂O₁₂, Ti-doped Li₇La₃Zr₂O₁₂, Ga-doped Li₇La₃Zr₂O₁₂, TiO₂, Al₂O₃, Fe₃O₄, and BaTiO₃.

25. The method of claim 12, further comprising the step of heating the precursor material at a temperature below the decomposition temperature of the polymers and below the formation temperature of the metal oxide to stabilize the morphology of the fibers or particles of the precursor materials prior to step (c).
